(19) United States
(12) Patent Application Publication
(10) Pub. No.: US 2010/0211904 A1
(43) Pub. Date: Aug. 19, 2010

(54) USER INTERFACE METHOD FOR INPUTTING A CHARACTER AND MOBILE TERMINAL USING THE SAME

(75) Inventors: Changhee Yun, Seoul (KR); Yunghee Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC

(21) Appl. No.: 12/707,654

(22) Filed: Feb. 17, 2010

(30) Foreign Application Priority Data
Feb. 19, 2009 (KR) 10-2009-0013887

(51) Int. Cl. G06F 3/048

(52) U.S. Cl. 715/773

(57) ABSTRACT

A user interface method for inputting characters and a mobile terminal using the same are disclosed. The user interface method includes: displaying a user interface including a magnified portion and a real time selected character display region of a virtual keypad on a display screen of a display module equipped with a touch/proximity sensor; displaying a character selected from the virtual keypad in real time on the real time selected character display region and storing the selected character in a memory; and reading a character string inputted so far from the memory when a certain time lapses or in response to a certain key input, and displaying a preview screen image including the character string on the display screen.

### CROSS-REFERENCE TO RELATED APPLICATIONS

This nonprovisional application claims priority under 35 U.S.C. §119(a) on Patent Application No. 10-2009-0013887 filed in Republic of Korea on Feb. 19, 2009, the entire contents of which are hereby incorporated by reference.

### BACKGROUND

1. Field

This document relates to a user interface method and a mobile terminal using the same.

2. Related Art

As functions of terminals such as personal computers, notebook computers, mobile phones, and the like, become more diversified, the terminals are implemented as multimedia players supporting complicated functions such as capturing images or video, reproducing music or video files, playing games, receiving broadcast signals, and the like.

In general, terminals may be divided into a mobile terminal and a stationary terminal according to whether or not terminals are movable. In addition, mobile terminals may be divided into a handheld terminal and a vehicle mount terminal according to whether or not users can directly carry it around.

Efforts are ongoing to support and increase the functionality of mobile terminals. Such efforts include software improvements as well as changes and improvements in the structural components forming the terminals. As the diverse terminals including a mobile terminal provide complicated, diverse functions, user interfaces tend to be complicated. The user interfaces allow users to easily access various functions of terminals and are being developed even to satisfy user sensitivity. In this respect, the existing user interface may rather cause user inconvenience depending on the structures of terminals. For example, compact terminals have smaller keypad, touch screen and display device displaying inputted characters, so they cannot use the conventional terminal character input method.

### SUMMARY

An aspect of this document is to provide a user interface method suitable for inputting of characters of a compact terminal, and a mobile terminal using the same.

In an aspect, a user interface method for inputting characters include: displaying a user interface including a magnified portion of a virtual keypad and a real time selected character display region on a display screen of a display module equipped with a touch/proximity sensor; displaying a character selected from the virtual keypad in real time on the real time selected character display region and storing the selected character in a memory; and when a certain time lapses or when a certain key is inputted, reading a character string inputted so far from the memory and displaying a preview screen image including the character string on the display screen.

In another aspect, a mobile terminal includes: a display module; a touch/proximity sensor mounted on the display module; and a controller configured to display a user interface including a magnified portion and a real time selected character display region of a virtual keypad on a display screen of the display module, analyze an output of the touch/proximity sensor to display a character selected from the virtual keypad on the real time selected character display region and store the selected character in a memory, read a character string inputted so far from the memory when a certain time lapses or in response to a certain key input, and display a preview screen image including the character string on the display screen.

### BRIEF DESCRIPTION OF THE DRAWINGS

The implementation of this document will be described in detail with reference to the following drawings in which like numerals refer to like elements.

FIG. 1 is a block diagram illustrating a configuration of a mobile terminal to which this document is applied;

FIG. 2 is a perspective view illustrating an external appearance of the mobile terminal to which this document is applied;

FIG. 3 is a flow chart illustrating a sequential process of controlling a user interface for inputting characters according to an exemplary embodiment of the present invention;

FIG. 4 illustrates an example of a virtual keypad and a real time selected character display region;

FIG. 5 illustrates an example of an operation of changing a character input screen image and a preview screen image;

FIG. 6 illustrates an example of displaying the number of remaining characters; and

FIGS. 7 and 8 illustrate an example of displaying a character newly inputted after characters are inputted up to a final column of the real time selected character display region.

### DETAILED DESCRIPTION

The foregoing and other objects, features, aspects and advantages of the present invention will become more apparent from the following detailed description of the present invention when taken in conjunction with the accompanying drawings. Exemplary embodiments of the present invention will now be described in detail with reference to the accompanying drawings. The same reference numerals will be used throughout to designate the same or like components. In describing the present invention, if a detailed explanation for a related known function or construction is considered to unnecessarily divert the gist of the present invention, such explanation will be omitted but would be understood by those skilled in the art.

The mobile terminal according to exemplary embodiments of the present invention will now be described with reference to the accompanying drawings. In the following description, usage of suffixes such as ‘module’, ‘part’ or ‘unit’ used for referring to elements is given merely to facilitate explanation of the present invention, without having any significant meaning by itself.

The mobile terminal described in the present invention may include mobile phones, smart phones, notebook computers, digital broadcasting terminals, PDAs (Personal Digital Assistants), PMPs (Portable Multimedia Player), navigation terminals, and the like.

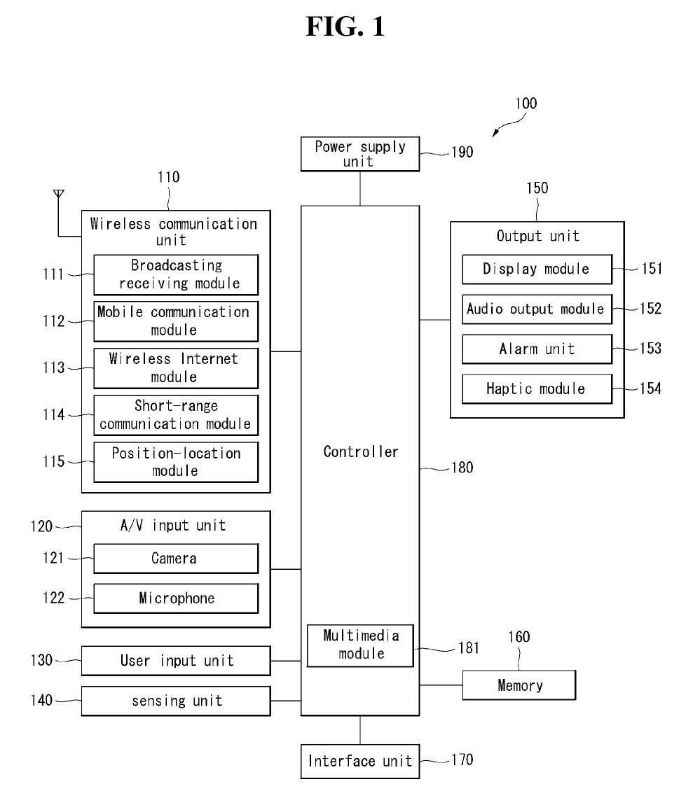

FIG. 1 is a block diagram of a mobile terminal according to an exemplary embodiment of the present invention.

With reference to FIG. 1, the mobile terminal 100 may include a wireless communication unit 110, an A/V (Audio/Video) input unit 120, a user input unit 130, a sensing unit 140, an output unit 150, a memory 160, an interface unit 170, a controller 180, a power supply unit 190, etc. FIG. 1 shows the mobile terminal as having various components, but it should be understood that implementing all of the illustrated components is not a requirement. Greater or fewer components may alternatively be implemented.

The wireless communication unit 110 typically includes one or more components allowing radio communication between the mobile terminal 100 and a wireless communication system or a network in which the mobile terminal is located. For example, the wireless communication unit 110 may include at least one of a broadcast receiving module 111, a mobile communication module 112, a wireless Internet module 113, a short-range communication module 114, and a position-location module 115.

The broadcast receiving module 111 receives broadcast signals and/or broadcast associated information from an external broadcast management server via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal obtained by combining a data broadcast signal with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive broadcast signals by using various types of broadcast systems. In particular, the broadcast receiving module 111 may receive a digital broadcast signal by using a digital broadcasting system such as multimedia broadcasting-terrestrial (DMB-T), digital multimedia broadcasting-satellite (DMB-S), media forward link only (MediaFLO®), digital video broadcast-handheld (DVB-H), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160.

The mobile communication module 112 transmits and/or receives radio signals to and/or from at least one of a base station, an external terminal, and a server. Such radio signals may include time information, a voice call signal, a video call signal, or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), WiBro (Wireless Broadband), WiMax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The position-location module 115 is a module for checking or acquiring a location of the mobile terminal. A typical example of the position-location module is a GPS (Global Positioning System). The GPS module 115 may calculate information regarding the distance from one point (entity) to three or more satellites and information regarding time at which the distance information was measured, and applies trigonometry to the calculated distance, thereby calculate three-dimensional location information according to latitude, longitude, and altitude with respect to the one point (entity). In addition, a method of acquiring location and time information by using three satellites and correcting an error of the calculated location and time information by using another one satellite may be also used. The GPS module 115 may continuously calculate the current location in real time and also calculate speed information by using the continuously calculated current location.

The A/V input unit 120 is configured to receive an audio or video signal. The A/V input unit 120 may include a camera 121 and a microphone 122. The camera 121 processes image frames of still pictures or video obtained by an image sensor in a video call mode or an image capturing mode. The thusly processed image frames may be displayed on a display module 151.

The image frames processed by the camera 121 may be stored in the memory 160 or transmitted to the exterior via the wireless communication unit 110. The mobile terminal 100 may include two or more cameras 121 mounted thereon.

The microphone 122 may receive an external audio signal via a microphone in a phone call mode, a recording mode, a voice recognition mode, and the like, and process such signal into electrical audio (voice) data. The processed audio (voice) data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 may generate input data from commands entered by a user to control various operations of the mobile terminal. The user input unit 130 may include various input units such as a keypad, a dome switch, a touch pad, a jog wheel, a jog switch, a track ball, a joy stick, and the like.

The sensing unit 140 detects a current status of the mobile terminal 100 such as an open or closed state of the mobile terminal 100, the location of the mobile terminal 100, the presence or absence of a user contact with the mobile terminal 100 (i.e., touch inputs), the orientation of the mobile terminal 100, an acceleration or deceleration of the mobile terminal 100, a movement of the mobile terminal 100, a change in the posture (i.e. a particular physical orientation) and angle of the mobile terminal 100, etc., and generates commands or signals for controlling the operation of the mobile terminal 100. In addition, the sensing unit 140 may detect whether or not the power supply unit 190 supplies power or whether or not the interface unit 170 is coupled with an external device and generate a corresponding sensing signal.

The sensing unit 140 may include a touch screen installed in the display module 151 or having a touch sensor stacked on the display module 151, and a proximity sensor for detecting the presence or absence of an object within a recognition-available proximity distance on the display module 151 or the touch screen or detecting a movement or gesture of the object. Also, the sensing unit 140 may include a gyro sensor, a terrestrial sensor, and the like, for detecting a change in the posture, orientation, angle, or the like, of the mobile terminal 100.

The proximity sensor may be disposed within or near the touch screen. The proximity sensor refers to a sensor for detecting the presence or absence of an object relative to a certain detection surface or an object that exists nearby by using the force of electromagnetism or infrared rays without a physical contact. Thus, the proximity sensor has a considerably longer life span compared with a contact type sensor, and it can be utilized for various purposes. Examples of the proximity sensor may include a transmission type photoelectric sensor, a direct reflection type photoelectric sensor, a mirror-reflection type photoelectric sensor, an RF oscillation type proximity sensor, a capacitance type proximity sensor, a magnetic proximity sensor, an infrared proximity sensor, and the like. The proximity sensor detects a proximity touch and a proximity touch pattern (e.g., a proximity touch distance, a proximity touch direction, a proximity touch speed, a proximity touch time, a proximity touch position, a proximity touch movement state, etc.). Information corresponding to the detected proximity touch operation and the proximity touch pattern may be outputted to the touch screen.

The touch sensor may be configured to convert a pressure applied to a particular portion of the display module 151 or a change in capacitance at a particular portion of the display module 151 into an electrical input signal. The touch sensor may be configured to detect even the pressure when a touch is applied, as well as a touched position or area. When a touch with respect to the touch sensor is inputted, corresponding signal (signals) are transmitted to a touch signal processing module of the controller 180. The touch signal processing module calculates coordinates of a touched point from the touch signal and transmits the calculated coordinates to the controller 180. Then, the controller 180 can recognize which portion of the display module 151 has been touched according to the coordinates values outputted from the touch signal processing module. In case where the touch sensor is implemented as a capacitive touch sensor, proximity of a pointer may be detected by a change in electric field according to the proximity of the pointer. In this case, the touch screen may be classified as a proximity sensor.

The output unit 150, which generates an output related to the sense of sight, the sense of hearing, or the sense of touch, may include the display module 151, an audio output module 152, an alarm unit 153, and a haptic module 154.

The display module 151 displays or outputs information processed in the mobile terminal 100. For example, the display module 151 may display a User Interface (UI) or a 2D and 3D Graphic User Interface (GUI), and the like, under the control of the controller 180. When the mobile terminal 100 is in a video call mode or image capturing mode, the display module 151 may display an image captured by the camera 121 and/or an image received via the wireless communication unit 110.

The display module 151 may include at least one of a Liquid Crystal Display (LCD), a Thin Film Transistor-LCD (TFT-LCD), an Organic Light Emitting Diode (OLED), a flexible display and a three-dimensional (3D) display.

The display module 151 may be configured to be transparent or light-transmissive to allow viewing of the exterior therethrough. With such a structure, the user can view an object located at a rear side of the terminal body through the region occupied by the display module 151 of the terminal body of the mobile terminal.

The display module 151 may include two or more physically or logically divided display modules. For example, a plurality of display modules 151 may be separately or integrally disposed on one surface of the mobile terminal 100 or may be separately disposed on different surfaces of the mobile terminal 100. The touch screen may be implemented by stacking a touch sensor on the display module 151 or installing the touch sensor within the display module 151. The touch screen may be used as both an image input device and an output device for receiving a user input.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to functions (e.g., a call signal reception sound, a message reception sound, etc.) performed by the mobile terminal 100. The audio output module 152 may include a receiver, a speaker, a buzzer, etc.

The alarm unit 153 may provide outputs to inform about the occurrence of an event of the mobile terminal 100. Typical events may include a call signal reception, a message reception, an e-mail reception, a key signal input, a touch input, a proximity input, etc. In addition to audio or video outputs, the alarm unit 153 may provide outputs in a different manner, for example, vibration, to inform about the occurrence of an event. A video signal or an audio signal may be also outputted via the display module 151 or the audio output module 152.

The haptic module 154 generates various tactile effects the user may feel. A typical example of the tactile effects generated by the haptic module 154 is vibration. The strength, pattern, and the like, of the vibration generated by the haptic module 154 can be controlled. For example, different vibrations may be combined to be outputted or sequentially outputted. Besides vibration, the haptic module 154 may generate various other tactile effects such as effects by stimulations such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat. The haptic module 154 may be also implemented to allow the user to feel a tactile effect through a muscle sensation such as user's fingers or arm, as well as transferring the tactile effect through a direct contact.

The memory 160 may store software programs used for the processing and controlling operations performed by the controller 180, or may store data such as a phonebook, messages, e-mails, still images, video, etc., that are inputted or outputted under the control of the controller 180. In addition, the memory 160 may store data regarding various patterns of sound effects, vibration patterns, and haptic patterns generated when a user performs inputting or when an event occurs. The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the interface unit 170 may receive data or power from an external device and transmit the same to each element of the mobile terminal 100, or transmit internal data of the mobile terminal 100 to an external device. For example, the interface unit 170 may include wireline or wireless headset ports, external charger ports, wireline or wireless data ports, memory card ports, ports for connecting a device having an identification module, audio input/output (I/O) ports, video I/O ports, earphone ports, or the like. When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The identification module, which is a chip that stores various information for authenticating the authority of using the mobile terminal 100, may include a user identity module (UIM), a subscriber identity module (SIM) a universal subscriber identity module (USIM), and the like. The identification module may be fabricated in the form of a smart card. Accordingly, the identification module may be connected with the mobile terminal 100 via an identification module port. The identification module stores phone numbers, call information, billing information, and the like.

The controller 180 typically controls the general operations of the mobile terminal. For example, the controller 180 performs controlling and processing associated with voice calls, data communications, video calls, message transmission and reception, and the like. The controller 180 may include a 3D image processing module (not shown) and a multimedia module 181. The 3D image processing module converts 3D data such as 3D map data, 3D user interface data, and the like, into a 3D image, and adjusts the angle, size, and the like, of the 3D image displayed on the display module 151 according to a direction change command based on a user input or a change in the angle of the mobile terminal 100. The multimedia module 181 processes signals to reproduce multimedia data. The controller 180 may perform a pattern recognition processing to recognize a handwriting input or a picture drawing input performed on the touch screen as characters or images, respectively.

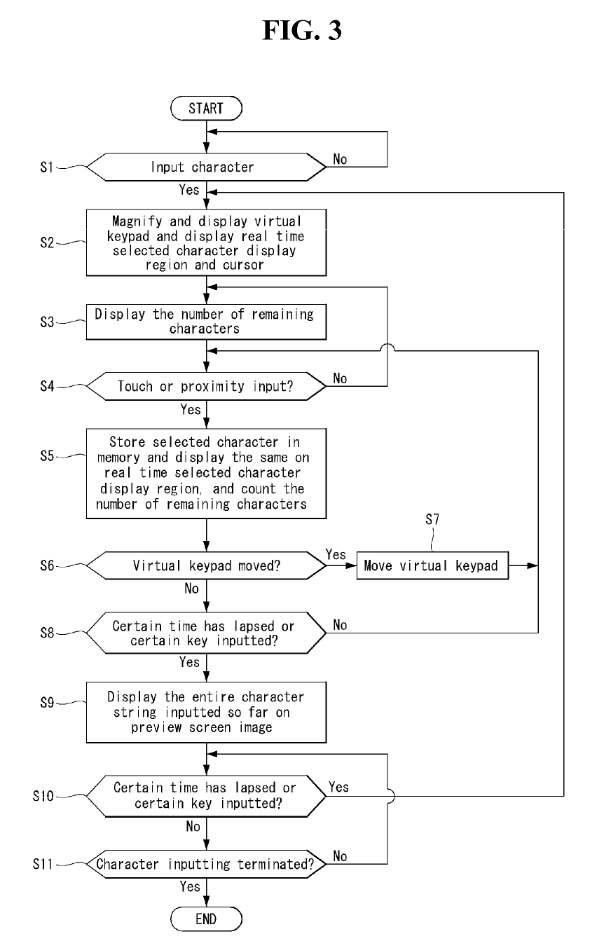

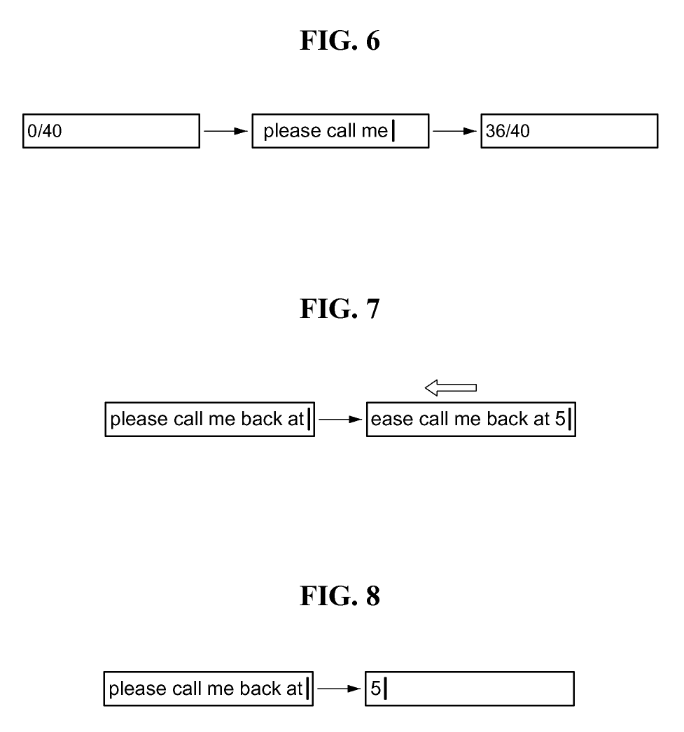

The controller 180 displays a 2D/3D user interface on the display module to allow the user to easily access various functions provided by the mobile terminal 100, processes user data and commands selected through the user interface, and executes an application selected by the user. The user interface includes a character input user interface for inputting characters selected by the user after being executed in an application required for character inputting such as a message creation, a memo creation, a schedule creation, and the like, to the memory 160. The character input user interface will be described in detail later with reference to FIGS. 3 to 7.

The controller 180 may be implemented by using at least one of ASICs (application specific integrated circuits), DSPs (digital signal processors), DSPDs (digital signal processing devices), PLDs (programmable logic devices), FPGAs (field programmable gate arrays), micro-controllers, and microprocessors. In some cases, those embodiments may be implemented by the controller 180.

The power supply unit 190 receives external power or internal power and supplies appropriate power required for operating respective elements and components under the control of the controller 180.

The following exemplary embodiments may be implemented by software, hardware, or their combination, and may be stored in a recording medium that can be read by a computer or the like.

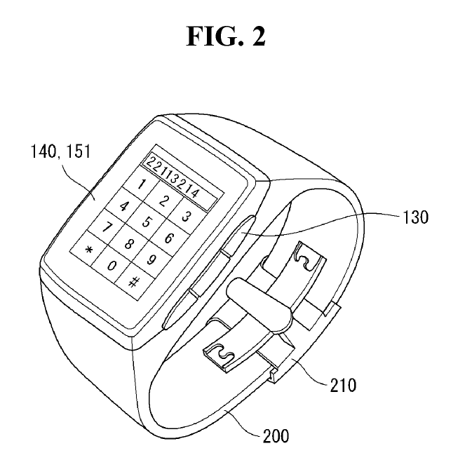

FIG. 2 is a perspective view illustrating an external appearance of the mobile terminal 100 to which this document is applied.

With reference to FIG. 2, the mobile terminal 100 includes a small body with some or the entirety of the elements or components illustrated in FIG. 1 integrated therein, a band 200 connected with both ends of the small body, and a buckle 210 for fastening or tightening the band 200. On a front surface of the small body, there are disposed a display screen of the display module 151, and a touch screen of the sensing unit 140 mounted within or on the display screen. An input means, for example, a keypad, a touch pad, or any other input means, of the input unit 130, may be disposed on the side of the small body. Besides an antenna for mobile communication, a broadcast signal receiving antenna may be disposed on the side of the small body, and the antenna(s) may be installed such that they can be extended from the small body.

The band 200 and the buckle 210 serve to fix the small body of the mobile terminal 100 to the user's wrist, like a wristwatch. The band 200 may be made of a synthetic resin, metal, a natural or artificial leather material, an elastic material, or any of their combinations. The buckle 210 may be made of metal. If the band 200 is made of a material with high elasticity, the buckle 210 may be omitted.

The mobile terminal 100 may be fabricated to have such a special structure as the wristwatch illustrated in FIG. 2. However, the present invention is not limited thereto and the mobile terminal 100 may be implemented in various other structures such as the existing bar type mobile terminal, or a slide type mobile terminal, a folder type mobile terminal, a swing type mobile terminal, a swivel type mobile terminal, which have two or more bodies coupled to be relatively movable.

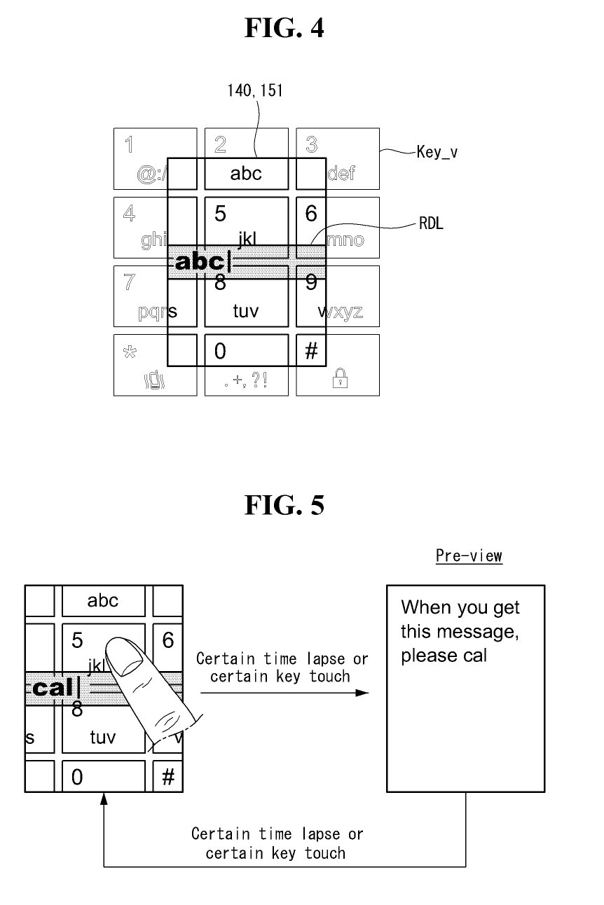

FIG. 3 is a flow chart illustrating a sequential process of controlling a user interface for inputting characters according to an exemplary embodiment of the present invention. FIGS. 4 to 8 illustrate the example of operations of user interfaces. The user interfaces of FIGS. 3 to 8 are executed under the control of the controller 180.

With reference to FIG. 3, when the user executes an application required for inputting characters such as a message creation, a memo creation, a schedule creation, and the like, the controller 180 displays a virtual key pad (Key_v) implemented by software on the display screen of the display module 151, and displays a real time selected character display region RDL showing characters selected by the user in real time as shown in FIG. 4 (S1 and S2). When the mobile terminal 100 is integrated in the small body as shown in FIG. 2, the display screen of the display module 151 is small. Thus, unless the virtual keypad (Key_v) of the mobile terminal integrated into the small body is magnified, a plurality of keys are likely to be selected simultaneously when a touch input or a proximity input of the user occurs from the virtual keypad (Key_v). Thus, in order to avoid such a problem, a portion of the virtual keypad (Key_v) is magnified to be displayed on the display screen of the display module 151 as shown in FIGS. 4 and 5, so that a plurality of characters may not be simultaneously selected in the compact mobile terminal.

When there is a need to input a character not seen on the display screen, the user may perform a touch or proximity dragging or manipulate a direction key (or a touch pad) disposed at the side of the mobile terminal body to move the virtual keypad (Key_v). Then, the controller 180 analyzes an output of the touch sensor or the proximity sensor to recognize the touch or proximity dragging applied on the virtual keypad (Key_v), determine a dragging direction and a dragging length, and move the virtual keypad (Key_v) by the dragging length, or recognize an output of a key (or the touch pad) to move the virtual keypad (Key_v).

The controller 180 may display the real time selected character display region RDL in an overlap manner on the virtual keypad (Key_v) as shown in FIGS. 4 and 5 in consideration of the restriction in the display screen. Also, the controller 180 may display the real time selected character display region RDL at an outer side of the virtual keypad (Key_v) so that it may not overlap with the magnified display portion of the virtual keypad (Key_v). The user may execute an environment setting application of a character input interface to adjust the transparency of the real time selected character display region RDL. Accordingly, in case of displaying the real time selected character display region RDL in an overlap manner on the virtual keypad (Key_v), the real time selected character display region RDL may be displayed to be transparent or translucent on the virtual keypad (Key_v) as shown in FIGS. 4 and 5. A moving cursor may be displayed on the real time selected character display region RDL according to character inputting.

The controller may display the number of inputtable characters on the real time selected character display region RDL or on the virtual keypad (Key_v) immediately after displaying the virtual keypad (Key_v) and the real time selected character display region RDL (S3). Although varied according to services of mobile communication providers, the number of characters for a message transmission free of charge is limited. The number of inputtable characters may be limited in creating memo or schedule content. Thus, if the number of remaining characters is displayed when the user inputs characters, the user can avoid a communication cost otherwise incurred in excess of the number of limited characters and check the number of remaining characters in creating a memo or a schedule. The number of remaining characters may be indicated in the form of ‘number of remaining characters/total number of allowable characters’. For example, if a total number of allowable characters is 40 and the number of remaining characters is 36, it can be indicated by ‘36/40’.

The number of remaining characters may be temporarily displayed in advance before character inputting whenever characters are successively inputted on a preview screen image. Also, the number of remaining characters may be continuously displayed at one side of the virtual keypad (Key_v) or the real time selected character display region RDL or may be periodically displayed at predetermined time intervals.

As shown in FIG. 5, with the virtual keypad (Key_v) and the real time selected character display region RDL displayed on the display screen of the display module 151, each time a user's touch or proximity input occurs, the controller 180 displays a character selected according to the user's touch or the proximity input on the real time selected character display region RDL. And the controller 180 stores user selected characters in the memory 160 and counts the number or remaining characters by subtracting the number of the inputted characters from the number of allowable characters (S4 and S5).

When the user moves the virtual keypad (Key_v) toward the user's touch or proximity dragging, the direction key, or the like, the controller 180 moves the virtual keypad (Key_v) on the display screen of the display module 151 and performs again step S$ to receive inputted characters (S6 and S7).

The controller 180 counts time (non-input time) during which there is no touch or proximity input on the virtual keypad (Key_v) and compares the non-input time with a certain threshold time duration in real time. If the non-input time is larger than the threshold time duration, the controller deletes the virtual keypad (Key_v) and the real time selected character display region from the screen of the display module 151, reads the entire character string which has been inputted so far from the memory 160 and displays the same on a preview screen image on the screen of the display module 151. If there is much character string which has been inputted so far in the preview state, the controller 180 scrolls the character string in a certain direction, e.g., in a vertical direction or in a horizontal direction, on the preview screen image. Also, when the user manipulates a certain key in the process of character inputting, the controller 180 may display a preview screen image in response to the corresponding key signal (S8 and S9).

With the preview screen image displayed on the display module 151, when the non-input time during which there is no touch or proximity input exceeds the certain threshold time or when a certain key is inputted, the controller 180 displays the virtual keypad (Key_v) and the real time selected character display region RDL on the display module 151 to receive a character again (S10).

When the user executes a menu to generate an event of a message input termination situation such as a message transmission, memo storing, and the like, the controller 180 deletes the virtual keypad (Key_v) and the real time selected character display region RDL from the display screen of the display module 151 and displays a user selected application screen image or a standby screen image on the display screen (S11).

The controller 180 displays user selected characters up to the final column of the real time selected character display region RDL, and when a new character is inputted as shown in FIG. 7, the controller shifts the previously inputted character string and displays the newly inputted character at the final column. Also, after displaying the user selected characters at the final column of the real time selected character display region RDL, when a new character is inputted, the controller 180 may delete the previously inputted character string and display the newly inputted character from the first column, as shown in FIG. 8.

When the controller 180 displays the user interface as shown in FIGS. 4 and 5, the controller 180 may display soft keys for selecting an upper case/lower case conversion, a foreign language conversion, and a special symbol input at one portion of the display screen of the display module 151 and change the characters of the virtual keypad (Key_v) according to a soft key input.

In FIG. 3, displaying a preview screen image, counting the number of remaining characters, displaying the number of remaining characters, and like, are not essential and thus may be omitted.

The user interface method according to exemplary embodiments of the present invention may be implemented by software. When executed by software, the elements of components of the present invention are code segments executing a required operation. Program or segments may be stored in a process-readable medium or transmitted by a computer data signal combined with a carrier in a transmission medium or a communication network.

A computer-readable recording medium includes any kind of recording device storing data that can be read by a computer system. The computer-readable recording device includes a ROM, a RAM, a CD-ROM, a DVD-ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A user interface method comprising:
displaying a user interface including a magnified portion of a virtual keypad and a real time selected character display region on a display screen of a display module equipped with a touch/proximity sensor;
displaying a character selected from the virtual keypad in real time on the real time selected character display region and storing the selected character in a memory; and
when a certain time lapses or when a certain key is inputted, reading a character string inputted so far from the memory and displaying a preview screen image including the character string on the display screen.

2. The method of claim 1, wherein the real time selected character display region overlaps with the virtual keypad.

3. The method of claim 2, wherein the real time selected character display region overlaps with the virtual keypad in a state of being transparent or translucent.

4. The method of claim 1, wherein the character is selected according to a touch or a proximity touch applied to the virtual keypad.

5. The method of claim 1, further comprising:
moving the virtual keypad displayed on the display screen in response to a touch and proximity dragging applied to the virtual keypad.

6. The method of claim 1, further comprising:
when a certain time lapses or when a certain key is inputted in a state that the preview screen image is displayed on the display screen, re-displaying the virtual keypad and the real time selected character display region on the display screen.

7. The method of claim 6, further comprising:
setting the number of allowable characters;
calculating the number of remaining characters by subtracting the number of already inputted characters from the number of allowable characters; and
displaying the number of remaining characters along with the number of allowable characters.

8. The method of claim 7, wherein the number of allowable characters and the number of remaining characters are displayed immediately after the virtual keypad and the real time selected character display region are displayed on the display screen, and displayed again on the display screen immediately after the preview screen image is changed to the display screen of the virtual keypad and the real time selected character display region.

9. A mobile terminal comprising:
a display module;
a touch/proximity sensor mounted on the display module; and
a controller configured to display a user interface including a magnified portion of a virtual keypad and a real time selected character display region on a display screen of the display module, analyze an output of the touch/proximity sensor to display a character selected from the virtual keypad on the real time selected character display region and store the selected character in a memory, read a character string inputted so far from the memory when a certain time lapses or in response to a certain key input, and display a preview screen image including the character string on the display screen.

10. The mobile terminal of claim 9, wherein the controller displays the real time selected character display region on the virtual keypad in an overlap manner.

11. The mobile terminal of claim 10, wherein the controller displays the real time selected character display region in a transparent or translucent state on the virtual keypad in an overlap manner.

12. The mobile terminal of claim 9, wherein the controller analyzes an output of the touch/proximity sensor to recognize a character inputted through a touch or proximity input on the virtual keypad.

13. The mobile terminal of claim 9, wherein the controller moves the virtual keypad displayed on the display screen in response to a touch/proximity dragging applied on the virtual keypad.

14. The mobile terminal of claim 9, wherein when a certain time lapses or when a certain key input occurs in a state that the preview screen image is displayed on the display screen, the controller re-displays the virtual keypad and the real time selected character display region on the display screen.

15. The mobile terminal of claim 14, wherein the controller sets the number of allowable characters, calculates the number of remaining characters by subtracting the number of already inputted characters from the number of allowable characters, and displays the number of remaining characters along with the number of allowable characters.

16. The mobile terminal of claim 15, wherein the controller displays the number of allowable characters and the number of remaining characters immediately after the virtual keypad and the real time selected character display region are displayed on the display screen, and displays again the number of allowable characters and the number of remaining characters on the display screen immediately after the preview screen image is changed to the display screen of the virtual keypad and the real time selected character display region.
